(19) United States
(12) Patent Application Publication
(10) Pub. No.: US 2015/0188240 A1
(43) Pub. Date: Jul. 2, 2015

(54) TRANSMITTING AND RECEIVING ARRAY ANTENNA APPARATUS WITH ULTRA HIGH ISOLATION

(71) Applicant: Electronics and Telecommunications Research Institute, Daejeon (KR)

(72) Inventors: Soon Young EOM, Daejeon (KR); Batgerel ARIUNZAYA, Daejeon (KR); Jae Ick CHOI, Daejeon (KR)

(21) Appl. No.: 14/585,763

(22) Filed: Dec. 30, 2014

(30) Foreign Application Priority Data
Dec. 31, 2013 (KR) 10-2013-0168871
Dec. 29, 2014 (KR) 10-2014-0192683

(51) Int. Cl. H01Q 21/24; H01Q 21/00; H01Q 21/28

(52) U.S. Cl. CPC H01Q 21/24; H01Q 21/28; H01Q 21/0075

(57) ABSTRACT

Provided is a Tx and Rx array antenna apparatus with ultra high isolation, the Tx and Rx array antenna apparatus including N antenna elements, and a feeding network to provide electrical signals having identical amplitudes and opposite phases to antenna elements facing each other, among the N antenna elements.

### CROSS-REFERENCE TO RELATED APPLICATION

This application claims the benefit of Korean Patent Application Nos. 10-2013-0168871, 10-2014-0192683 filed on Dec. 31, 2013, Dec. 29, 2014 in the Korean Intellectual Property Office, the disclosure of which is incorporated herein by reference.

### BACKGROUND

1. Field of the Invention

Embodiments of the present invention relate to a transmitting and receiving (hereinafter, Tx and Rx) array antenna apparatus with ultra high isolation.

2. Description of the Related Art

An isolation characteristic between input ports of a Tx and Rx array antenna in conventional antenna technology may simply depend on an isolation characteristic of Tx and Rx elements provided in a dual-orthogonal feeding structure. An additional Tx and Rx isolation characteristic may satisfy a required Tx and Rx port isolation characteristic using a band suppression and a band pass characteristics of Tx and Rx front-end filters. However, in single-channel dual-duplex communication to use an identical frequency, Tx and Rx signal separation effect may not be achieved by the Tx and Rx front-end filters.
In general, the single-channel dual-duplex communication antenna using an identical frequency may require an ultra high isolation characteristic over 100 decibels (dB) between a Tx antenna and a Rx antenna. Thus, implementation of such a Tx and Rx antenna may be impossible in the related art.
A relatively simple method involves obtaining an isolation characteristic required between the Tx antenna and the Rx antenna by spatially separating the Tx antenna from the Rx antenna. However, such a method may be faced with a realistic issue of an excessive increase in a system volume in terms of a space and thus, may be unfeasible.

Accordingly, to develop a single-channel dual-duplex communication system to increase frequency utilization, implementation of an ultra high isolation characteristic between Tx and Rx ports of a Tx and Rx antenna operating within the same radiation area may be required.

In this regard, Korean Patent Application Publication No. 2011-0070426 suggests “A multi input multi output antenna for improving the isolation characteristic”.

### SUMMARY

An aspect of the present invention provides a Tx and Rx array antenna apparatus with an ultra high isolation characteristic between Tx and Rx ports, and operating within the same radiation area, as related to an antenna technology that may play a significant role in development of a single-channel dual-duplex communication system to increase frequency utilization.

According to an aspect of the present invention, there is provided a Tx and Rx array antenna apparatus including N antenna elements, and a feeding network to provide electrical signals having identical amplitudes and opposite phases to antenna elements facing each other, among the N antenna elements.

N may correspond to “4”.

The N antenna elements may correspond to dual-orthogonal feeding antenna elements having one of an orthogonal polarization characteristic, a linear polarization characteristic, and a circular polarization characteristic.

A length of a transmission line in the feeding network may be determined based on a spatial mutual coupling characteristic among the N antenna elements.

The feeding network may include a T-junction power dividing/combining network or a Wilkinson dividing/combining network.

The feeding network may be configured to divide a signal excited from a port Tx port into N signals and to feed the divided N signals to the N antenna elements, and to combine N signals induced from the N antenna elements into a signal and to transfer the combined signal to a Rx port.

Each of the N antenna elements may include N Tx and Rx antenna elements, and a feeding network to provide electrical signals having identical amplitudes and opposite phases to Tx and Rx antenna elements facing each other, among the N Tx and Rx antenna elements.

According to another aspect of the present invention, there is also provided a Tx and Rx array antenna apparatus including a first antenna element, a second antenna element, a third antenna element, a fourth antenna element, a transmission port, a reception port, a first junction to connect the first antenna element, the second antenna element, and a sixth junction, a second junction to connect the second antenna element, the third antenna element, and a fifth junction, a third junction to connect the third antenna element, the fourth antenna element, and the sixth junction, a fourth junction to connect the fourth antenna element, the first antenna element, and the fifth junction, the fifth junction to connect the transmission port the fourth junction, and the second junction, and the sixth junction to connect the Rx port, the first junction, and the third junction.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a configuration of a Tx and Rx array antenna apparatus with an ultra high isolation characteristic according to an embodiment of the present invention;

FIGS. 2A and 2B are diagrams illustrating a recursive configuration of a Tx and Rx array antenna apparatus with an ultra high isolation characteristic according to an embodiment of the present invention; and

FIG. 3 is a diagram illustrating a recursive configuration of a Tx and Rx array antenna apparatus with an ultra high isolation characteristic according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

Hereinafter, a Tx and Rx array antenna apparatus with an ultra high isolation and a method of obtaining a Tx and Rx isolation characteristic in the apparatus will be described in detail with reference to the accompanying drawings.

To achieve the foregoing, antenna elements having a dual-orthogonal feeding characteristic, and a predetermined polarization characteristic, for example, one of a linear polarization characteristic and a circular polarization characteristic may be used.

To increase a Tx and Rx isolation characteristic and a directivity characteristic, in a feeding structure of an array antenna to be arrayed two-dimensionally at an optimal array spacing corresponding to a radiation characteristic of an antenna element, a 2×2 array antenna in which four Tx and Rx antenna elements have an identical polarization characteristic, and input ports disposed to face each other have a relative phase difference of 180° may be used.

To increase more a Tx and Rx isolation characteristic and a directivity characteristic, a expanded Tx and Rx array antenna apparatus with recursive array configuration using a same differential feeding network may be provided.

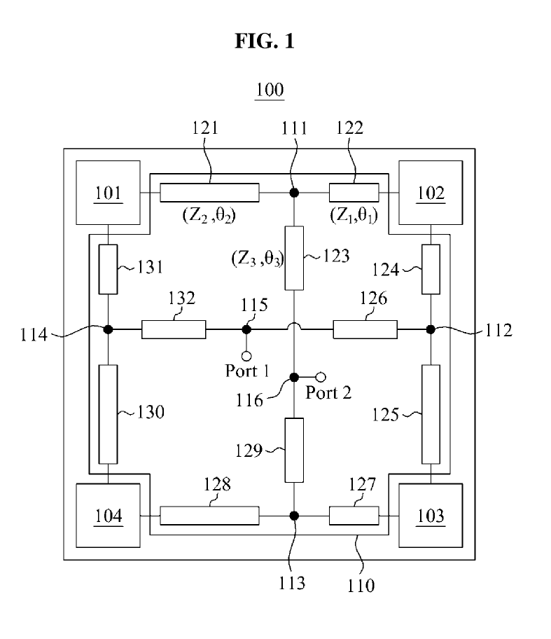

FIG. 1 is a diagram illustrating a configuration of a Tx and Rx array antenna apparatus 100 with an ultra high isolation characteristic according to an embodiment of the present invention. In an example, the Tx and Rx array antenna apparatus 100 may be provided using 2×2 array antennas.

Referring to FIG. 1, the Tx and Rx array antenna apparatus 100 may be provided in a structure having vertical and horizontal symmetries. The Tx and Rx array antenna apparatus 100 may include Tx and Rx antenna elements 101 through 104, and junctions 111 through 116. The Tx and Rx antenna elements 101 through 104 and the junctions 111 through 116 may be connected by transmission lines 121 through 132. The Tx and Rx array antenna apparatus 100 may include an input port and an output port. In the present embodiment, Port 1 denotes a Tx input port, and Port 2 denotes a Rx output port.

A Tx and Rx feeding network 110 used in the Tx and Rx array antenna apparatus 100 may provide electrical signals having identical amplitudes and opposite phases to Tx and Rx antenna elements facing each other, among the Tx and Rx antenna elements 101 through 104. The Tx and Rx feeding network 110 may internally perform a Tx feeding network function to divide a single into signals based on a number of Tx and Rx antenna elements, for example, into four signals in the present embodiment, and a Rx feeding network function to combine signals induced in Rx ports of the Tx and Rx antenna elements into one signal. The Tx and Rx feeding network 110 may include a T-junction power dividing/combining network or a Wilkinson power dividing/combining network. In the present embodiment, the T-junction power dividing/combining network is used.

The configuration of the Tx and Rx array antenna apparatus 100 will be described in detail.

The Tx and Rx array antenna apparatus 100 may include a first Tx and Rx antenna element 101, a second Tx and Rx antenna element 102, a third Tx and Rx antenna element 103, and a fourth Tx and Rx antenna element 104. A Tx port and a Rx port may be provided at a fifth junction 115 and a sixth junction 116, respectively.

To connect the Tx and Rx antenna elements 101 through 104, the Tx and Rx array antenna apparatus 100 may include a first junction 111 that connects the first Tx and Rx antenna element 101, the second Tx and Rx antenna element 102, and the sixth junction 116, a second junction 112 that connects the second Tx and Rx antenna element 102, the third Tx and Rx antenna element 103, and the fifth junction 115, a third junction 113 that connects the third Tx and Rx antenna element 103, the fourth Tx and Rx antenna element 104, and the sixth junction 116, and a fourth junction 114 that connects the fourth Tx and Rx antenna element 104, the first Tx and Rx antenna element 101, and the fifth junction 115.

In addition, the fifth junction 115 may connect the Tx port, the fourth junction 114, and the second junction 112, and the sixth junction 116 may connect the Rx port, the first junction 111, and the third junction 113.

A configuration of transmission lines will be described by assigning reference numerals to the transmission lines, respectively, starting from a first transmission line to a twelfth transmission line.

A first transmission line 121 may connect the first Tx and Rx antenna element 101 and the first junction 111, a second transmission line 122 may connect the first junction 111 and the second Tx and Rx antenna element 102, and a third transmission line 123 may connect the first junction 111 and the sixth junction 116.

A fourth transmission line 124 may connect the second Tx and Rx antenna element 102 and the second junction 112, a fifth transmission line 125 may connect the second junction 112 and the third Tx and Rx antenna element 103, and a sixth transmission line 126 may connect the second junction 112 and the fifth junction 115.

As described above, input/output (I/O) devices and transmission lines of each Tx and Rx antenna element may have vertical and horizontal symmetries. Thus, a seventh transmission line 127 may connect the third Tx and Rx antenna element 103 and the third junction 113, an eighth transmission line 128 may connect the third junction 113 and the fourth Tx and Rx antenna element 104, and a ninth transmission line 129 may connect the third junction 113 and the sixth junction 116.

The Tx and Rx array antenna apparatus 100 may further include a tenth transmission line 130 that connects the fourth Tx and Rx antenna element 104 and the fourth junction 114, an eleventh transmission line 131 that connects the fourth junction 114 and the first Tx and Rx antenna element 101, and a twelfth transmission line 132 that connects the fourth junction 114 and the fifth junction 115.

An operating principle of the Tx and Rx array antenna apparatus 100 will be described. A signal excited into the Tx port of Port 1 may be divided by a circuit of the fifth junction 115 having an identical signal dividing characteristic, pass through the sixth transmission line 126 and the twelfth transmission line 132 having identical transmission line characteristics, be divided into the fourth transmission line 124 and the fifth transmission line 125, and into the tenth transmission line 130 and the eleventh transmission line 131 through a circuit of the second junction 112 and a circuit of the fourth junction 114 having identical signal dividing characteristics, respectively, and be fed into the respective Tx and Rx antenna elements 101 through 104 facing one another.

A signal excited into the first Tx and Rx antenna element 101 may be radiated by the first Tx and Rx antenna element 101 as an electromagnetic wave having a vertical polarization characteristic in a free space. In this example, an electrical parameter (Z₂, θ₂) of the first transmission line 121 and an electrical parameter (Z₁, θ₁) of the second transmission line 122 may have differential feeding characteristics, for example, electrical characteristics of identical characteristic impedances and opposite phases, for example, a phase difference of 180°.

The first transmission line 121, the fifth transmission line 125, the eighth transmission line 128, and the tenth transmission line 130 may have electrical characteristics of identical characteristic impedances and identical phases. The second transmission line 122, the fourth transmission line 124, the seventh transmission line 127, and the eleventh transmission line 131 may have electrical characteristics of identical characteristic impedances and identical phases. The third transmission line 123, the sixth transmission line 126, the ninth transmission line 129, and the twelfth transmission line 132 may have electrical characteristics of identical characteristic impedances and identical phases. The first transmission line 121, the fifth transmission line 125, the eighth transmission line 128, and the tenth transmission line 130, and the second transmission line 122, the fourth transmission line 124, the seventh transmission line 127, and the eleventh transmission line 131 may have electrical characteristics of identical characteristic impedances and a phase difference of 180°.

A spatial mutual coupling characteristic among the Tx and Rx antenna elements 101 through 104 may cause a isolation performance deterioration of the Tx and Rx array antenna apparatus 100. Thus, prediction of a mutual coupling characteristic to be determined by a spatial array spacing among the Tx and Rx antenna elements 101 through 104, and consideration of the predicted mutual coupling characteristic in the Tx and Rx feeding network 110 may be required.

Herein, an embodiment of the present invention suggests a method of optimizing an electrical length of a transmission line in the Tx and Rx feeding network 110. When such a method is used, the degraded isolation characteristic between Tx and Rx ports may be recovered.

An operating principle for receiving mode of the Tx and Rx array Tx and Rx antenna apparatus 100 will be described. An electromagnetic signal having a horizontal polarization characteristic may be induced through each of the Tx and Rx antennas 101 through 104 from the free space, and pass through transmission lines. Induced four electromagnetic signals may be combined through circuits of the T-junctions 111 and 113 having identical power combining characteristics. Combined two signals may pass through the transmission lines 123 and 129. They may be combined again through a circuit of the sixth junction 116 having an identical power combining characteristic, and may be fed to the Rx port of Port 2.

A method of obtaining a Tx and Rx isolation characteristic of the Tx and Rx array antenna apparatus 100 will be described as follows.

A signal excited into the Tx port of Port 1 may be fed into each Tx input port of the four Tx and Rx antenna elements 101 through 104 through a Tx power dividing circuit in the Tx and Rx feeding network 110. In this example, a transmitted signal may be primarily isolated by a Tx and Rx isolation characteristic, for example, a suppression characteristic of about 20 to 25 dB, of each antenna element with orthogonal Tx and Rx ports Remaining Tx signal may be suppressed through a Rx feeding network. The remaining Tx signal may be secondarily isolated by, for example, a suppression characteristic of about 50 to 60 dB, and is fed to the Rx port of Port 2.

Thus, the Tx and Rx isolation characteristic of over about 70 dB may be obtained through the Tx and Rx array antenna apparatus 100.

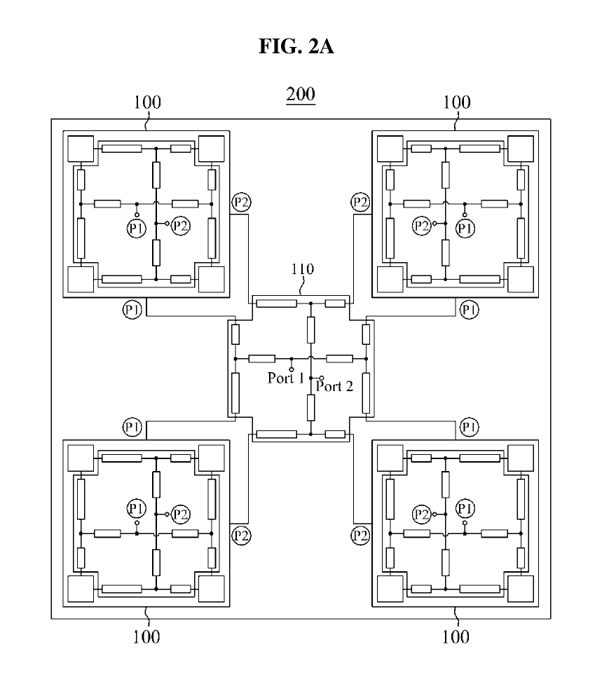

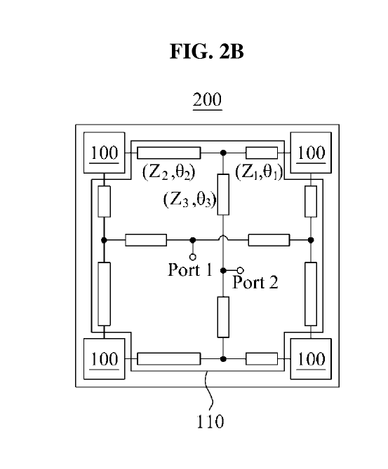

FIGS. 2A and 2B are diagrams illustrating a recursive configuration of a Tx and Rx array antenna apparatus 200 with an ultra high isolation characteristic according to an embodiment of the present invention.

The recursive configuration of the Tx and Rx array antenna apparatus 200 may be suggested using the configuration of the Tx and Rx array antenna apparatus 100 of FIG. 1, through which a Tx and Rx isolation characteristic may be obtained in two stages.

FIG. 2A illustrates a circuit of the Tx and Rx array antenna apparatus 200 provided in a 4×4 form. Referring to FIG. 2A, Tx and Rx array antenna apparatuses 100 may be disposed to have vertical and horizontal symmetries. A circuit configuration similar to the Tx and Rx feeding network 110 of FIG. 1 may be used as a Tx and Rx feeding network. FIG. 2B illustrates a miniature configuration of the Tx and Rx array antenna apparatus 200.

An operation of the Tx and Rx array antenna apparatus 200 will be described hereinafter. Transmitted signals leaked from the Tx and Rx array antenna apparatuses 100 disposed to have vertical and horizontal symmetries may have identical amplitudes and opposite phases. Thus, the leaked transmitted signals may be isolated in two stages after remaining Tx signals thereof are suppressed through receiving power combining circuits in the Tx and Rx feeding network 110, and may be fed to a Rx port of Port 2. In this example, an isolation characteristic of about 50 to 60 dB may be suppressed.

To maintain an ultra high isolation characteristic, the four Tx and Rx array antenna apparatuses 100 and the single Tx and Rx feeding network 110 may require a method to completely exclude a mutual coupling characteristic between Tx and Rx feed network. In an example, a method of mechanically separating the four Tx and Rx array antenna apparatuses 100 and the single Tx and Rx feeding network 110, and connecting the four Tx and Rx array antenna apparatuses 100 and the single Tx and Rx feeding network 110 using a coaxial cable may be employed.

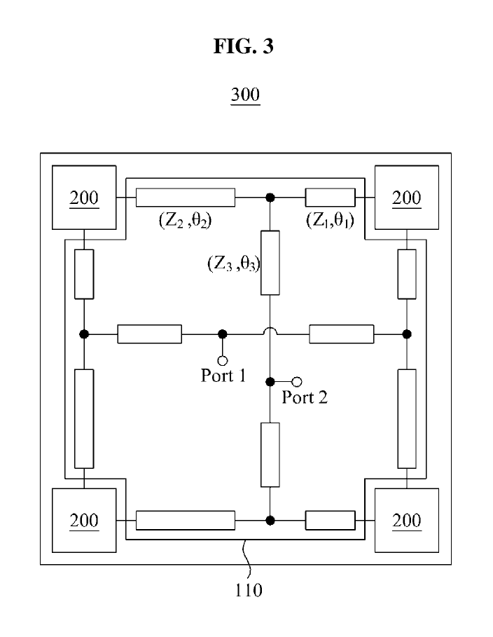

Thus, the isolation characteristic of over about 120 dB may be obtained through the Tx and Rx array antenna apparatus 200. FIG. 3 is a diagram illustrating a recursive configuration of a Tx and Rx array antenna apparatus 300 with an ultra high isolation characteristic according to an embodiment of the present invention. In an example, the Tx and Rx array antenna apparatus 300 may be provided using 8×8 array antennas by disposing Tx and Rx 4×4 array antenna apparatuses 200 configured in two stages to have vertical and horizontal symmetries.

However, in practice, a Tx and Rx isolation characteristic of about 90 dB may be obtained due to the unexpected leaky interference between Tx and Rx feed network and unexpected spurious radiation from Tx and Rx feed networks and unexpected reflections or scattering from a non-homogenous radome surface or mechanic edge-wall. Thus, an extension of more than a 4×4 array may increase a directivity characteristic of an antenna, but may not guarantee an increase in the Tx and Rx isolation characteristic.

According to an embodiment of the present invention, a Tx and Rx array antenna having an ultra high characteristic and operating in the same radiation area may be directly utilized as an antenna for a signal-channel dual-duplex communication system to increase frequency utilization. In addition, the Tx and Rx array antenna may be widely applied as next generation wireless communication antenna technology requiring an ultra high isolation characteristic.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A Transmitting and Receiving (Tx and Rx) array antenna apparatus comprising:
four antenna elements, each having an orthogonal polarization characteristic, disposed to face one another to have vertical and horizontal symmetries, and arrayed in two rows and two columns; and
a differential feeding network to provide electrical signals having identical amplitudes and a relative phase difference of 180° to antenna elements facing each other, among the four antenna elements.

2. The Tx and Rx array antenna apparatus of claim 1, wherein an electrical length of a transmission line in the differential feeding network is adjusted by reflecting a spatial mutual coupling characteristic among the four antenna elements.

3. The Tx and Rx array antenna apparatus of claim 1, wherein the Tx and Rx array antenna is iteratively expanded and connected to the differential feeding network to be disposed in an n×m array, n being a multiple of “2” and m being a multiple of “4”.

4. A Tx and Rx array antenna apparatus comprising:
four 2×2 array antenna elements disposed to face one another to have vertical and horizontal symmetries, and arrayed in two rows and two columns; and
a differential feeding network to provide electrical signals having identical amplitudes and a relative phase difference of 180° to antenna elements facing each other, among the four 2×2 array antenna elements.

5. The Tx and Rx array antenna apparatus of claim 4, wherein the four 2×2 array antenna elements are mechanically separated and connected to one another using a coaxial cable to exclude a spatial mutual coupling characteristic among the four 2×2 array antenna elements.

6. A Tx and Rx array antenna apparatus comprising:
N antenna elements; and
a feeding network to provide electrical signals having identical amplitudes and opposite phases to antenna elements facing each other, among the N antenna elements.

7. The Tx and Rx array antenna apparatus of claim 6, wherein N corresponds to “4”.

8. The Tx and Rx array antenna apparatus of claim 6, wherein the N antenna elements correspond to dual-orthogonal feeding antenna elements having orthogonal polarization characteristics.

9. The Tx and Rx array antenna apparatus of claim 6, wherein a length of a transmission line in the feeding network is determined based on a spatial mutual coupling characteristic among the N antenna elements.
